(19) United States
(12) Patent Application Publication
(10) Pub. No.: US 2005/0210141 A1
(43) Pub. Date: Sep. 22, 2005

(54) Method for providing multiple sdp media flows in a single pop context

(75) Inventors: Johnson Oyama, Tokyo (JP); Magnus Olsson, Stockholm (SE)

Correspondence Address: ERICSSON INC., 6300 LEGACY DRIVE, M/S EVR C11, PLANO, TX, 75024, US

(73) Assignee: Telefonaktiebolaget LM Ericsson (publ), Stockholm (SE)

(21) Appl. No.: 10/501,443

(22) PCT Filed: Jan. 31, 2003
(86) PCT No.: PCT/EP03/00993

§ 371 Date: Jul. 13, 2004

Related U.S. Application Data
(60) Provisional application No. 60/352,548, filed on Jan. 31, 2002.

(51) Int. Cl. G06F 15/16

(52) U.S. Cl. 709/228; 709/232

(57) ABSTRACT

The invention relates to a method enabling multiple session description protocol media flows for one packet data protocol context. Therefore an indicator is sent from a P-CSCF to a user equipment indicating that a particular session description protocol media flow can be combined with further session description protocol media flows in a single packet data protocol context.

### TECHNICAL FIELD

The invention relates to a method and means for setting up multiple SDP (Session Description Protocol) media flows for a PDP (Packet Data Protocol) context.

### PRIOR ART

It has been recognised in 3GPP recently, that there needs to be simplification in the way SDP media flows are assigned to PDP contexts. The main driver for this is the charging requirements, whereby operators would like to bundle session and bearer level charges for particular SDP media flows.

The existing GPRS mechanisms as for example described in 3GPP specification TS 23.060, Version 3.9.0 of October 2001, already allow QoS (Quality of Service) policing, and counting of packets on a PDP context granularity. The TFTs (Traffic Flow Template) in the GGSN (Gateway General packet radio service Support Node) allow further filtering on the IP (Internet Protocol) level-user packet. There is thus a possibility to reuse these existing GPRS (General Packet Radio Service) mechanisms to satisfy the charging requirements in a simple manner. To this end, there has been some proposals to mandate one SDP media flow per PDP context. This in effect, allows the one-to-one correspondence of one PDP context to one SDP media stream, hence the GPRS QoS policing, and counting packets capabilities are reused.

However, there are drawbacks in implementing a one-to-one relation between SDP media flow and PGP context.

The current NSAPI (Network Service Access Point Identifier) code-point limit is 11. From a usage point of view, this could limit future expandability of IMS (IP Multi-media System), if the signalling PDP context, RTP/RTCP (Real Time Protocol/Real Time Control Protocol) separation, possibility for multiple chat sessions and other possible future usages are taken into account. From a UTRAN (Universal Terrestrial Radio Access Network), and SGSN (Serving General packet radio service Support Node) point of view, there are practical limits on the maximum number of PDP contexts that can be active at the same time, otherwise, the solution becomes too expensive to the operator.

Thus it is object of the invention to provide a method and means that overcome said drawbacks. This is achieved by the method of claim 1, the user equipment of claim 4, the packet call state control function of claim 5 and the serving GPRS support node of claim 6.

### SUMMARY

It is one object of the invention to provide a method for providing multiple session description protocol media flows for one packet data protocol context. The method comprises the step of sending from a packet-call state control function to a user equipment, a session initiated protocol message comprising an indication that a particular session description protocol media flow can be combined with further session description protocol media flows in a single packet data protocol context. The step of receiving said message in the user equipment, the step of interpreting the indicator, the step of selecting a packet data protocol context, and of sending a set-up request message for setting up said packet data protocol context comprising an authorisation token and identifiers of session description protocol media flows.

In an embodiment of the invention, the method the indication is sent from a home network of the user equipment to a visited network wherein the user equipment is currently located and is cached in said visited network before it is sent to the user equipment. In an embodiment of the invention, the indication conveys information whether the home network requires policing for each media flow, counting of packets per media flow, or flow independent policing.

Another object of the invention is user equipment comprising electronic circuitry adapted to interpret an indication received that a particular session description protocol media flow can be combined with further session description protocol media flows in a single packet data protocol context, a selection unit for selecting further media flows that can be combined with the particular session description protocol media flow and a processing unit adapted to control the user equipment and to initiate a sending of a set-up request message comprising an authorisation token and identifiers of session description protocol media flows.

A further object of the invention is a packet-call state control function adapted to send a message comprising an indication that a particular session description protocol media flow can be combined with further session description protocol media flows in a single packet data protocol context.

Also object of the invention is a gateway general packet radio service support node adapted to enforce a policy for handling a set-up request for a packet data protocol context wherein a single session description protocol media flow shall be combined with further session description protocol media flows, the policy received from a packet call state control function.

### BRIEF DESCRIPTION OF THE DRAWINGS

FIG. 1 depicts a part of a network as state of the art,

FIG. 2 depicts a signalling sequence for setting up a PDP context for a roaming subscriber, and

FIG. 3 depicts a resource reservation signalling flow.

### DETAILED DESCRIPTION

Since the network and user equipment capabilities and limitation as well as the charging models will vary it is not possible to find a single mapping of IP flows/SDP media flows to PDP contexts that fulfils all requirements. The invented method therefore provides the network the possibility to inform the user equipment on how to map the media and control flows described in SDP to PDP contexts. The mapping instructions are be conveyed in SIP messages from the network to the user equipment. The mapping instructions will be carried for example in a (3GPP specific) XML body in the SIP message. The mapping instructions information allows the network to request several combination of flows on a PDP context, e.g. all flows on one PDP context, separate PDP contexts for each RTP, RTCP, Signalling, etc.

For the specific case of mapping SDP media flows to PDP contexts, the following is introduced, SIP messages are enhanced with an indication for user equipment when a particular media flow is possible to multiplex with other media flows in a single PDP context. In a preferred embodiment of the invention, the default, or when the indication is not present, is one media flow per PDP context, i.e., the media flow cannot be multiplexed with other media flows in a PDP context.

A user equipment according to the invention has the capability to recognise this indication. It is further adapted to process a call according to the indication and to request the set-up of an appropriate packet data protocol context.

In the case that a subscriber is roaming, i.e. that her user equipment is located in a visited network, the indication is sent from the home network. The indication basically conveys the intention of the home operator either to have specific QoS policing/count of packets for a particular media flow, i.e., the fine granularity case, hence the media flow should be alone in one PDP context, or to allow the simplified policing/no media flow level counting of packets nor media flow level QoS policing, i.e., the course granularity case, hence multiplexing is OK. The decision which policy applies is at the home network since the home network owns the services, and because it is home network decision how the bundling of session-bearer shall look like to their subscribers.

The visited network P-call state control function/PCF (Policy Control Function or Policy Decision Function) caches the indication sent from the home network, and enforces that the user equipment obeys the home network request.

The user equipment sets up the PDP context of his choice, and includes the necessary authorisation token and flow identifiers. It is possible to multiplex different media flows in one PDP context if the home operator allows it, i.e., the indication is present.

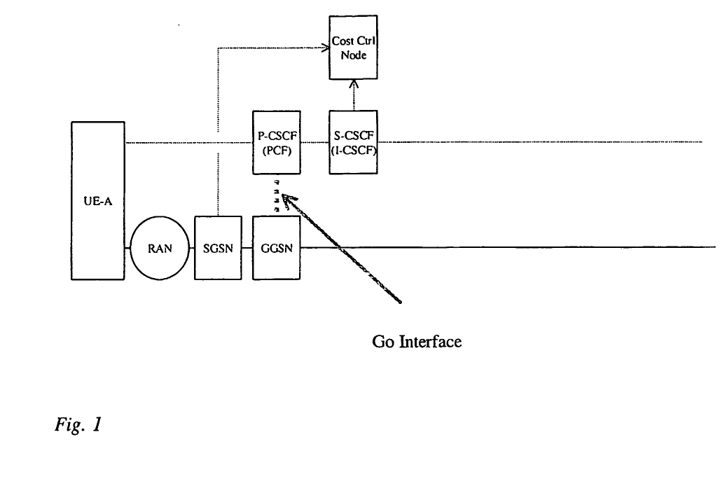

The visited network enforces the indication with the following, if the request for a particular media flow was that only one SDP media flow per PDP context is permitted, and the user equipment activates a PDP context with more than one flow identifiers the P-CSCF/PCF/GGSN then authorizes only one media flow, downgrades the PDP context QoS to fit the authorized QoS for the media flow, and notifies the user equipment of the media flow that was authorised via the PDP context response. The user equipment is then, in effect, notified to activate another PDP context for the other media flows. The GGSN enforces the uplink/downlik filter, for example by means of TFTs. Said filter may be sent over the Go interface as depicted in FIG. 1. In another embodiment of the invention, if there is an indication from the network for ‘no multiplexing’ and the user equipment requires a single PDP context associated to more than one SDP media flow, the PDP context activation may also simply be rejected, for example with an appropriate error cause.

In the case that a subscriber roams into a visited network and if multiplexing is allowed for all media flows included in one PDP context activation, the P-CSCF/PCF/GGSN permits the PDP context activation, for example after checking that the summed QoS is within the authorized limit of the sums. Therefore, however, no 3rd level will be implemented, no media flow level counting of packets nor media flow level QoS policing. At most only uplink/downlink filter like TFTs enforcements are done per PDP context at the GGSN. Said TFTs may be sent down over the Go interface between P-CSCF and Gateway GPRS support node. The uplink/downlink filters may not provide functionality beyond what is currently possible with the TFT.

Regarding RTP/RTCP, as described above, the network notifies mapping instructions information to user equipment, which enables the network to request the combination on a PDP contexts, e.g. separate or common PDP context for RTP and RTCP.

To that end, for example a ‘RTCP’ indication flag is created and used by the user equipment during PDP context activation. The user equipment uses this flag to indicate to the network the intention of using the PDP context for RTCP packets. The network (GGSN/P-CSCF/PCF) authorises the use of the ‘RTCP’ flag, according to the mapping instructions information. For the case that a common PDP context is used, the P-call state control function decision on the media flow applies to both RTP/RTCP which are in effect, considered by the network as ‘one flow’. In SIP/SDP, RTCP is not explicitly described under the m=line, but is implied to exist. RTP and RTCP have neighbouring port numbers, and are considered as being part of the same protocol.

For the case when a different PDP context is used for RTCP, authorisation from the P-CSCF/PCF may or may not be needed, depending on operator choice. A suitable plain GPRS interactive bearer may also be used for all RTCP traffic, no ‘RTCP’ flag, which is charged on volume and not bundled to the session, if the operator allows this.

In the following the invention will be described in more detail by means of figures.

FIG. 1 depicts user equipment UE-A and a part of a network comprising a Radio access network RAN, a Serving GPRS support node SGSN, a Gateway GPRS support node GGSN, a packet call state control function P-CSCF, a serving call server control function S-CSCF, and a node performing charging functions Cost CTRL Node. Depicted as a dotted line is the Go interface between the packet call server control function P-CSCF and the Gateway GPRS support node GGSN. In an embodiment of the invention the Gateway GPRS support node GGSN receives over said Go interface an indication of the policy for setting up a PDP context. In a preferred embodiment of the invention it further receives over the Go interface filters for enforcing said policy.

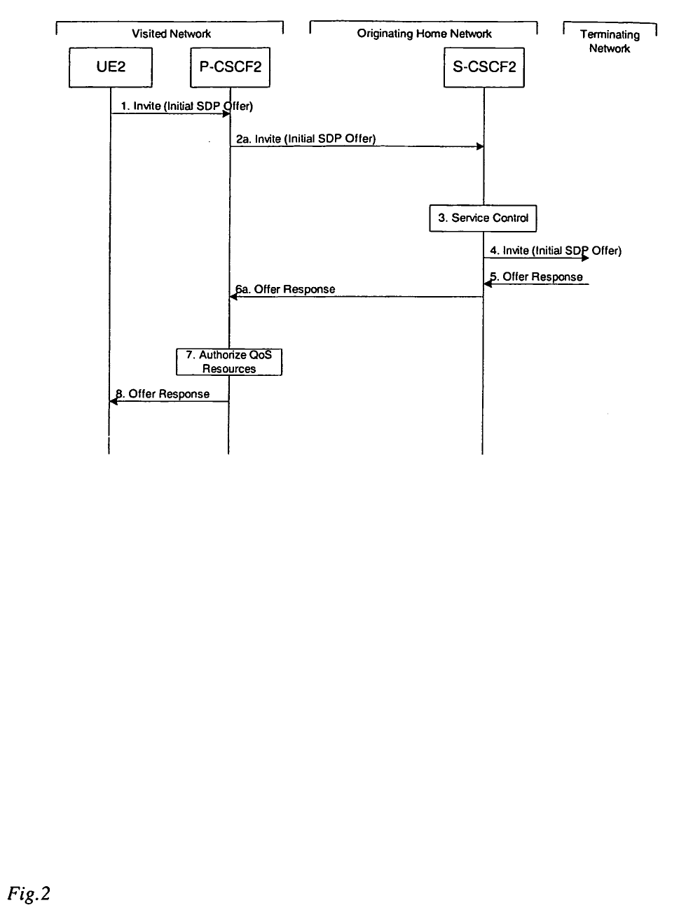

FIG. 2 depicts signalling sequence for setting up a PDP context for a roaming subscriber between a user equipment UE2, a packet call server control function P-CSCF2, a serving call server control function CSCF2, and a terminating network that is not depicted. In a first step 1 the user equipment UE2 sends a SIP INVITE request, containing an initial SDP, to the packet call server control function P-CSCF2, determined via a CSCF discovery mechanism. The initial SDP may represent one or more media for a multi-media session. The packet call server control function P-CSCF2 of the visited network forwards the message to the serving call server control function S-CSCF2 of the home network of the user equipment UE2 in a next step 2a. The packet call server control function P-CSCF2 knows for example from the registration procedure the serving call server control function S-CSCF2 of the user equipment UE2.

In an embodiment of the invention wherein the home network of the user equipment performs configuration hiding, the messages sent between the packet call server control function and the serving call server control function are sent via an intermediate call server control function that is performing the configuration hiding function for the home network operator.

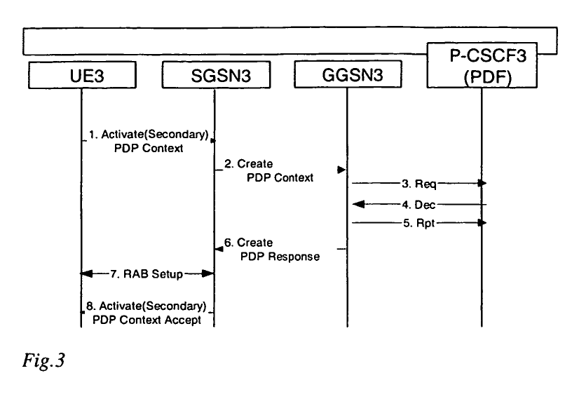

The serving call server control function performs service control which will be described in more detail by means of FIG. 3. If the result of the service control is that the context shall be set-up, the serving call server control function forwards the message to the terminating network. In a next step 5, the serving call server control function S-CSCF receives the media stream capabilities of the destination in an offer response message. The serving call server control function S-CSCF adds the indication that a particular session description protocol media flow can be combined with further session description protocol media flows in a single packet data protocol context to the offer response message and sends it to the packet call server control function P-CSCF2 in a next step 6a. The packet call server control function P-CSCF2 caches the indicator in a next step 7 and authorizes quality of service resources. In a next step 8 it sends an offer response to the user equipment UE2. The user equipment UE2 receives said message, interprets the indicator, selects a packet data protocol context, and sends a set-up request message for setting up said packet data protocol context comprising an authorisation token and identifiers of session description protocol media flows.

FIG. 3 depicts a resource reservation signalling flow between a user equipment UE3 a serving GPRS support node SGSN3, a Gateway GPRS support node GGSN3 and the packet call server control function P-CSCF3. The user equipment UE3 sends an Activate (Secondary) PDP Context message to the serving GPRS support node SGSN3 with UMTS QoS parameters. The user equipment UE3 includes Binding Information in the Activate PDP Context message. In a next step 2 the serving GPRS support node SGSN3 sends the corresponding Create PDP Context message to the Gateway GPRS support node GGSN3. In a following step 3 the Gateway GPRS support node GGSN3 sends a COPS REQ message with the Binding Information to a PDF (Policy Decision Function) in order to obtain relevant policy information. The PDF sends a COPS DEC message back to the Gateway GPRS support node GGSN3 in a next step 4. Afterwards the Gateway GPRS support node GGSN3 sends a COPS RPT message back to the PDF. The Gateway GPRS support node GGSN3 maps IP flow based policy information into PDP context based policy information and uses the PDP context based policy information to accept the PDP activation request, and sends a Create PDP Context Response message back to the serving GPRS support node SGSN3 in a following step 6. RAB setup is done by the RAB Assignment procedure in a next step 7. The serving GPRS support node SGSN3 sends an Activate (Secondary) PDP Context Accept message to the user equipment UE3.

1-6. (canceled)

7. A method for providing multiple session description protocol media flows for one packet data protocol context, comprising the steps of:
sending, from a packet-cscf to a user equipment, a session initiated protocol message comprising an indication that a particular session description protocol media flow can be combined with further session description protocol media flows in a single packet data protocol context; and
receiving said message in the user equipment, which performs the steps of:
interpreting the indicator;
selecting a packet data protocol context; and
sending a set-up request message for setting up said packet data protocol context, said message comprising an authorization token and identifiers of session description protocol media flows.

8. The method according to claim 7, wherein the indication is sent from a home network of the user equipment to a visited network wherein the user equipment is currently located and is cached in said visited network before it is sent to the user equipment.

9. The method according to claim 8, wherein the indication conveys information indicating whether the home network requires policing for each media flow, counting of packets per media flow, or flow independent policing.

10. User equipment for providing multiple session description protocol media flows for one packet data protocol context, said equipment comprising:
electronic circuitry adapted to interpret an indication received by said equipment that a particular session description protocol media flow can be combined with further session description protocol media flows in a single packet data protocol context
a selection unit for selecting further media flows that can be combined with the particular session description protocol media flow; and
a processing unit adapted to control the user equipment and to initiate the sending of a set-up request message comprising an authorisation token and identifiers of session description protocol media flows.
